(19) United States
(12) Patent Application Publication
(10) Pub. No.: US 2012/0167388 A1
(43) Pub. Date: Jul. 5, 2012

(54) SYSTEM AND METHOD FOR DISASSEMBLING TURBINE COMPONENTS

(75) Inventors: Stephen Hugh Black, Duanesburg, NY (US); Richard Francis Gutta, Greer, SC (US); Anil Mishra, Jaipur (IN); Kumaran Vale Mudaliar, Bangalore (IN)

(73) Assignee: GENERAL ELECTRIC COMPANY, Schenectady, NY (US)

(21) Appl. No.: 12/981,458

(22) Filed: Dec. 29, 2010

(51) Int. Cl. B23P 17/00; B23P 19/00

(52) U.S. Cl. 29/888; 29/700

(57) ABSTRACT

Systems and methods are provided for disassembling turbine components. A system is provided that includes a turbine tool. The turbine tool is configured to loosen an interference fit between a first component and a second component of a turbine system. The turbine tool is also configured to apply a thermal medium to an inner portion of the first component of the turbine system.

### BACKGROUND OF THE INVENTION

The subject matter disclosed herein relates to turbine systems, and more particularly, to systems and methods for disassembling turbine components.

Turbine systems include turbine components such as rotors, compressors, and turbines. Disassembling turbine components is a time consuming and complex operation. A rotor, for example, may include multiple rotor wheels positioned co-axially with respect to a shaft. Disassembling the rotor involves removal of components such as the rotor wheels. Unfortunately, the rotor wheels may be fastened by joints, which may be difficult to disengage. Further, many such joints are in locations that are difficult to access.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine tool. The turbine tool is configured to loosen an interference fit between a first component and a second component of a turbine system. The turbine tool is also configured to apply a thermal medium to an inner portion of the first component of the turbine system.

In a second embodiment, a system includes a turbine tool controller. The turbine tool controller is configured to control a turbine tool to loosen an interference fit between a first component and a second component of a turbine system. The turbine tool controller is also configured to control application of a thermal medium by the turbine tool to an inner portion of the first component of the turbine system.

In a third embodiment, a method includes applying a thermal medium to an inner portion of a first component of a turbine system. The method also includes controlling application of the thermal medium to loosen an interference fit between the first component and a second component of the turbine system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-section side view of a turbine system including a compressor and a rotor, in accordance with certain embodiments of the present technique;

FIG. 2 depicts a logic suitable for creating a thermal and structural model for use in disassembling components, in accordance with certain embodiments of the present technique;

FIG. 3 depicts a logic suitable for the application of hot and/or cold medium for use in the disassembly of components, in accordance with certain embodiments of the present technique;

FIG. 4 is a schematic view of a controller controlling a heat source in accordance with certain embodiments of the present technique;

FIG. 5 is a cross-section view of a rotor wheel and a thermal disassembly tool, in accordance with certain embodiments of the present technique;

FIG. 6 is a cross-section view of a rotor wheel and a thermal disassembly tool, in accordance with certain embodiments of the present technique; and

FIG. 7 is a cross-section view of a rotor wheel and a thermal disassembly tool, in accordance with certain embodiments of the present technique.

### DETAILED DESCRIPTION OF THE INVENTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

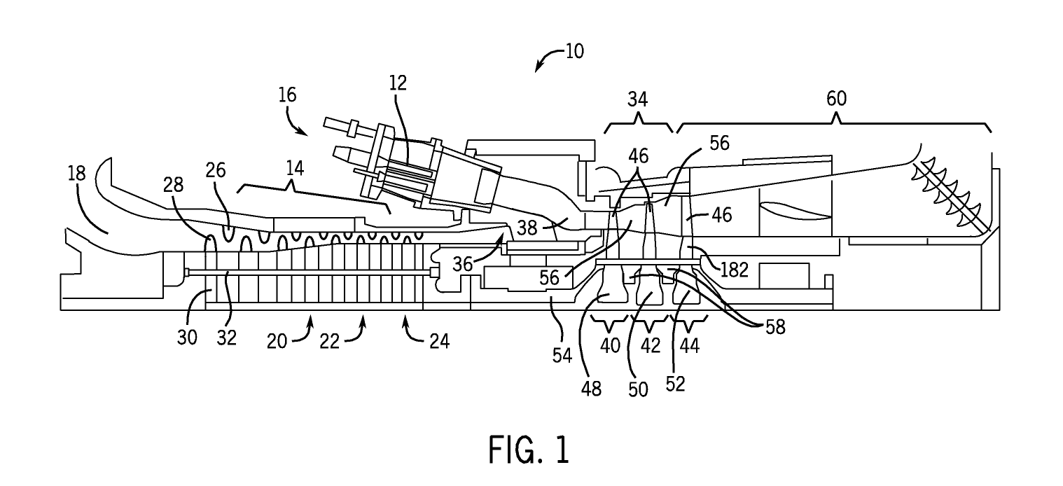

The disclosed embodiments are directed to techniques and systems for the disassembly of turbine components such as rotors, compressors, and turbines. Indeed, any type of component that may be secured by using, for example, an interference fit could be disassembled by using the techniques described herein. Some components, such as rotor components, include a multitude of rotor wheels or stages that may be positioned co-axially or concentrically on a shaft. Such rotor wheels may be positioned inside of a turbine system, such as the turbine system described in more detail with respect to FIG. 1 below. The rotor wheels may be mated to spacers using, for example, a rabbet joint having an interference fit. The interference fit, e.g., press fit or friction fit, may include compressive and tensile force components that enhance the fastening strength of the interference fit. That is, mechanical features of the rabbet joint, such as a male end (e.g., ridge or protrusion) inserted into a female end (e.g., groove), may create a compressive force at the rabbet joint, securing the rotor wheel firmly in place. Similar fastening techniques may be used to secure compressor components, pump components, and other rotating components.

In certain embodiments, a thermal and structural model of various turbine components or structures, such as rotor wheels, spacer assemblies, and/or rabbet joints may be created. The thermal and structural model may be capable of modeling the thermal behavior, including thermal expansion and contraction, of the various turbine components. Accordingly, techniques suitable for describing thermal responses, such as computational fluid dynamics (CFD), finite element analysis (FEA), solid modeling (e.g., parametric and non-parametric modeling), and 3-dimension to 2-dimension FEA mapping may be employed in creating the thermal and structural model. The application of a hot and/or cold medium may be modeled and the resulting stress responses, such as mechanical stresses, may also be modeled. Such a thermal and structural model may then be used in the design of both the turbine tools (e.g., thermal disassembly tools) and the process to apply heat and cold to a variety of locations, including inner portions of turbine components (e.g., wheel bores, wheel faces), exterior surfaces, and other rotating components. Indeed, the hot and cold medium may be applied to various locations on a component as described in more detail herein. The resultant thermal response may be suitable for disengaging mated structures while minimizing stresses levels. Additionally, the thermal response may be suitable for optimizing the disassembly of the rotor structures by reducing the time needed to disengage the multiple components that make up a system such as the rotor. Indeed, the techniques described herein enable a faster and more efficient disassembly of components, such as the components of the turbine system described in more detail below with respect to FIG. 1.

With the foregoing in mind and turning now to FIG. 1, a cross-sectional side view of an embodiment of a gas turbine system 10 is illustrated. The gas turbine system 10 may be used, for example, in a power generation plant. As described further below, certain components of the gas turbine system 10, such as a turbine section 34 and a compressor section 14, include components that may be fastened through rabbet joints having interference fits. These structures may be more efficiently disassembled through selective applications of a hot and/or cold medium, as described in more detail below.

The gas turbine system 10 includes a combustor 16. A fuel supply may route a liquid fuel or gas fuel, such as natural gas, to the turbine system 10 through one or more fuel nozzles 12 into the combustor 16. In certain embodiments, the gas turbine engine 10 may include multiple combustors 16 disposed in an annular arrangement or any other suitable arrangement. Further, each combustor 16 may include multiple fuel nozzles 12 attached to or near the head end of each combustor 16 in an annular or other arrangement.

Air may enter the gas turbine engine 10 through an air intake section 18 and may be compressed by the compressor 14. The compressor 14 may include a series of stages 20, 22, and 24 that compress the air. Each stage may include one or more sets of stationary vanes 26 and blades 28 that rotate to progressively increase the pressure to provide compressed air. The blades 28 may be attached to rotating wheels 30 connected to a shaft 32. In certain embodiments, the blades 28, wheels 30, and other structures of the compressor section 14 may be disassembled by first creating a thermal and structural compressor model of the compressor components. The compressor model may include thermal radiation, conduction, and convection modalities that enable the prediction of the thermal behavior of the compressor and related structures. A hot and/or cold medium may then be applied based on the compressor model, which allows certain components, such as compressor wheels 30, to be more easily disassembled and removed from the turbine system 10. A similar technique may be used to disassemble other components of the turbine system 10, including components of the turbine rotor 34, as described in more detail below.

The compressed discharge air from the compressor section 14 may exit the compressor section 14 through a diffuser section 36 of the compressor section 14 and may be directed into a section of the combustor section 16 where the compressed air may be mixed with fuel. For example, the fuel nozzles 12 may inject a fuel-air mixture into the combustors 16 in a suitable ratio for optimal combustion, emissions, fuel consumption, and power output. As noted above, multiple combustors 16 may be annularly disposed within the combustor section 16. Each combustor 16 may include a transition piece 38 that directs the hot combustion gases from the combustor 16 to the turbine section 34. In particular, each transition piece 38 may generally define a hot gas path from the combustor 16 to a nozzle assembly of the turbine section 34, included within a first stage 40 of the turbine section 34.

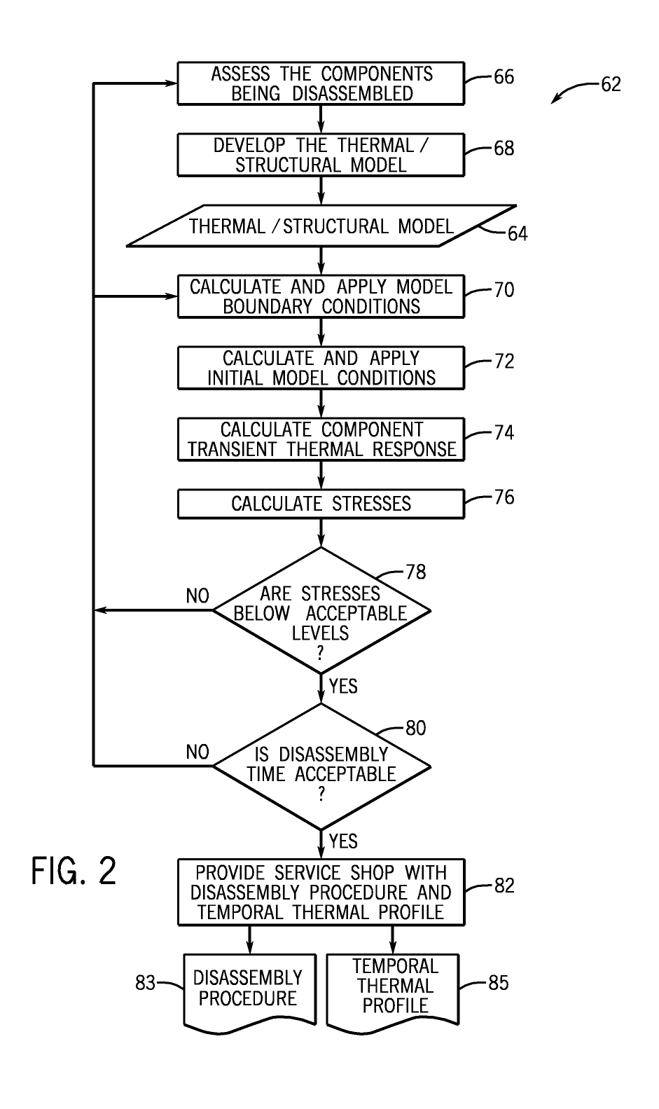

As depicted, the turbine rotor 34 includes three separate stages 40, 42, and 44. Each stage 40, 42, and 44 may include a set of blades 46 coupled to a respective rotor wheel 48, 50, and 52. The rotor wheels 48, 50 and 52 may be rotatably attached to a shaft 54. As the hot combustion gases cause rotation of turbine blades 46, the shaft 54 rotates to drive the compressor section 14 and any other suitable load, such as an electrical generator. Eventually, the gas turbine engine 10 diffuses and exhausts the combustion gases through the exhaust section 60. The rotor wheels 48, 50, and 52 may be securely fastened to spacers 58, using, for example, rabbet joints having an interference fit. As mentioned above, a thermal and structural model of components and related structures of the turbine rotor 34 may be created. The thermal and structural model may include thermal radiation, conduction, and convection modalities that enable the prediction of the thermal behavior of the rotor and related structures. A hot and/or cold medium may then be applied to the rotor based on the thermal and structural model, which allows certain components, such as the rotor wheels 48, 50 and 52, to be more easily disassembled and removed from the turbine system 10. In certain embodiments, a logic, such as the logic described in more detail with respect to FIG. 2 below, may be used to create a thermal and structural model suitable for optimizing the disassembly of various structures, such as the components of the turbine system 10. Such a model may include a temporal temperature profile, which details the progressive application of a hot or cold medium to various locations (e.g., wheel bore, wheel faces) of the turbine components.

FIG. 2 is illustrative of an embodiment of a logic 62 that may be used to create a thermal and structural model 64 suitable for the disassembly of components, such as the turbine section 34 or the compressor 14. The logic 62 may first carry out an assessment of the components undergoing disassembly (block 66). The assessment 66 may include determining potential component locations useful for applying a hot and/or cold medium. For example, if the component is a rotor wheel, or a wheel face, a wheel bore, and/or secondary flow holes may be used to apply the hot and/or cold medium. Likewise, if the component is the compressor, locations may include wheel faces, wheel bores, and other locations. Other locations may include rabbet joints structures, spacer surfaces, and so forth. Indeed, any number of component locations may be assessed to determine their suitability in enabling the thermally-aided disassembly of turbine components. Some of these assessed locations may then be chosen to receive applications of hot and/or cold medium.

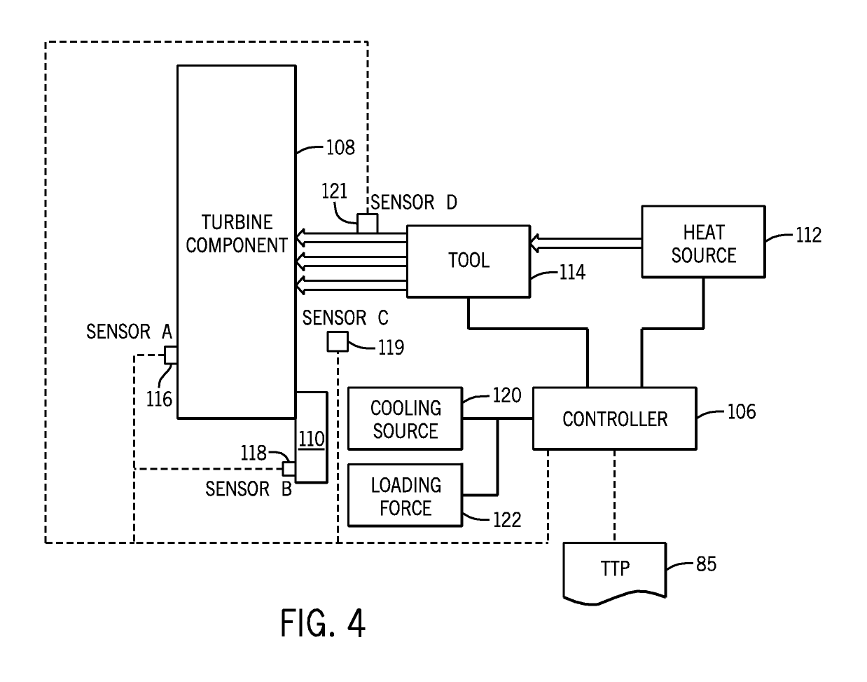

The chosen locations may be more efficiently accessed by the use of a turbine tool (e.g., thermal disassembly tool) that can apply thermal energy. For example, a location such as a rotor wheel bores, may be more efficiently accessed by using a pipe or conduit suitable for delivering a hot fluid to the bore. Accordingly, the assessment of the components (block 66) may include a design of the thermal disassembly tool or tools having conduits capable of accessing various locations, such as wheel faces, wheel bores, flow holes, and other locations. Such tools may enable the use of the hot fluid, such as a gas or a liquid, which can deliver thermal energy into selected locations. The designs of such turbine tools may then be used to construct the actual turbine tools. Some example thermal disassembly tools are described in more detail below with respect to FIGS. 4-7 below.

The assessment of the components (block 66) may also include an analysis of stress levels of each of the assessed components. More specifically, thermal gradients experienced by a component may result in thermal stresses. The thermal stress of the component, depending on the component's material properties and the method of manufacture (e.g., casting, forging, and milling), may not be desired. Accordingly, stress levels of each component may be analyzed so as to determine desired or acceptable levels of stress by which the component's life is maximized. In certain embodiments, techniques such as computational fluid dynamics (CFD), finite element analysis (FEA), solid modeling (e.g., parametric and non-parametric modeling), and 3-dimension to 2-dimension FEA mapping may be used to enable the analysis of stress levels suitable for maximizing component lifespan. For example, a set of sub-models may be created that include an analysis of how a hot (or cold) fluid may flow through the various turbine components, how the component's materials may respond to the thermal flow, how thermal gradients may develop, and how thermal stresses may arise based on any thermal gradients. Further, heating (and cooling) of the components through conductive, convective, and radiant heat transfer may also be analyzed.

The thermal and structural model 64 may then be developed (block 68) based on the aforementioned analysis (e.g. CFD, FEA, solid modeling, and/or 3-dimension to 2-dimension FEA mapping). The thermal and structural model 64 may be used, as described in more detail below, with certain controller (e.g., thermal controller, turbine tool controller) embodiments suitable for delivering hot and/or cold medium. In one example, the thermal and structural model 64 includes a set of boundary conditions. The boundary conditions aid in refining the scope of the model, for example by specifying the fluid behavior and properties at the boundary of the problem being solved. The boundary conditions include restraints on the model 64, such as values for heat transfer coefficients of different materials, temperature ranges for fluids that may be used, mechanical constraints (e.g., rigid body constraints, movement constraints), interference fit values (e.g., interference pressure, friction force, transmission torque). Accordingly, the boundary conditions may be calculated and applied to the thermal and structural model 64 (block 70).

A set of initial conditions may then be calculated and applied to the model 64 (block 72). The initial conditions may include, for example, a temperature field and a stress field for the disassembled components at a time t₀. The temperature field may include a multitude of starting temperature points and/or vectors distributed across the various modeled structures that make up the disassembled components. Likewise, a stress field corresponding to the temperature field may include stresses representative of the starting temperatures of the temperature field. The model 64 may then be used to calculate the thermal responses (e.g., responses to thermal convection, conduction, and/or radiation) of the individual components in the structures (block 74) to the hot and/or cold medium. For example, thermal gradients resulting from the application of hot and/or cold fluid may be simulated at various times t₀, t₁, . . . , tₙ. The thermal gradients may result in different areas of the components expanding (or contracting) by different amounts.

In certain embodiments, the logic 62 may iteratively calculate the thermal responses to the application of hot and/or cold fluid beginning from the initial time t₀ until reaching a time tₙ. Accordingly, stresses associated with the thermal responses (e.g., thermal gradients) may be calculated at various times (e.g., progressively from time t₀ until reaching the time tₙ) (block 76). Stress is the internal resistance or counterforce of a material to the distorting effects of, for example, the thermal gradients. The stress calculations (block 76) may be performed for the various components being disassembled as well as for joints (e.g., rabbet joints), and other related components (e.g., adjacent components).

The stress calculations may then be compared to desired maximum stress levels to determine whether stresses are below acceptable levels (decision 78). The desired maximum stress levels may be derived based on properties of the materials (e.g., tensile strength, compressive strength), the type of manufacture (e.g., forging, casting, and milling), the geometry of the component, and/or the intended application (e.g. duty cycle, environmental conditions, design life). If the calculated stresses are at acceptable levels (decision 78), then the logic determines if a disassembly time is acceptable (decision 80). The determination of an acceptable disassembly time may include using logged records of typical median and/or average disassembly times, thermal analysis including the use of the model 64, and/or human factor studies of disassembly procedures. For example, an acceptable time may be a time approximately equal to or less than the average or median disassembly time recorded before the implementation of the techniques described herein. In one embodiment, if the disassembly time is not found to be acceptable (decision 80), or if the stresses are not found to be at acceptable levels (decision 78), then the logic 62 may iterate so as to re-calculate and re-apply the model based on revised or updated boundary conditions (block 70). The iteration based on the new set of boundary conditions and/or initial conditions may result in acceptable stress levels and acceptable disassembly times. For example, thermal energy values may be increased and a new initial thermal field may be used.

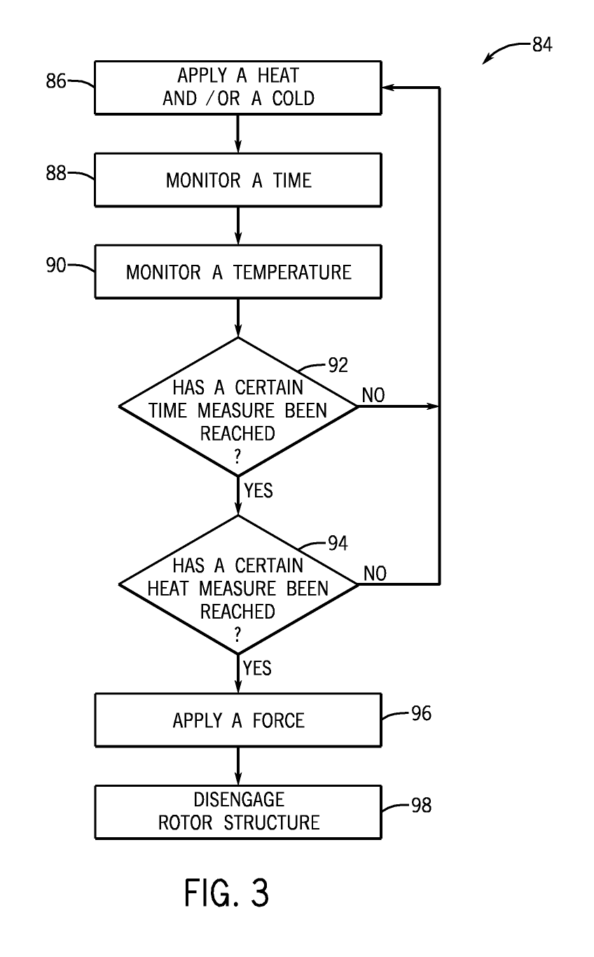

In another embodiment, if the disassembly time is not found to be acceptable (decision 80), or if the stresses are found not to be at acceptable levels, then the logic 62 may iterate and re-assess the components being disassembled (block 66). Re-assessing the components (block 66) may allow for an evaluation of different component locations on which to apply thermal energy. The thermal and structural model 64 may then be updated to account for the revised re-assessment of the locations. The logic 62 may then be used as described above to find stresses below acceptable levels (decision 78) and to find an acceptable disassembly time (decision 80). If the disassembly time is found to be acceptable (decision 80) and if the stress levels are found to be at acceptable levels, then the logic 62 may provide a service shop with a disassembly procedure 83 and/or a temporal thermal profile 85. The disassembly procedure 83 may include, for example, a disassembly logic as described in FIG. 3 useful in disassembling turbine components. The disassembly procedure 83 may also include the particulars on the use of thermal disassembly tools and on the application of mechanical forces (e.g., loading forces) suitable for separating the turbine components. The temporal thermal profile 85 may include details on the temporal application of thermal energy that may be used, for example, by an automation controller (e.g., thermal controller, turbine tool controller) as described in more detail below with respect to FIG. 4.

FIG. 3 illustrates an embodiment of a disassembly logic 84 that may be used to more efficiently and quickly disassemble turbine components, such as compressors and/or turbine sections. The logic 84 may include non-transitory machine readable code or computer instructions that may be used by a computing device (e.g., closed-loop controller) to transform sensor inputs, such as temperature inputs, into outputs such as actuator outputs. Heat may first be applied (block 86), for example, by using the thermal disassembly tools described in more detail below. The applied heat may include conduction, convection, and/or radiation heat. For example, a hot fluid (e.g., hot air or hot water) may be heated by a hot air source and directed so as to impinge the inner portion of a component such as a rotor wheel bore. In another example, a chemical source such as an exothermic chemical source (e.g., chemical heating pad) may be used to provide the heat. In yet another example, an electric heater such as a heating blanket may be used to provide the heat. In certain embodiments, the heat is applied to an inner portion of the component, such as approximately near or on the center of mass of the component (e.g., wheel bore, wheel face). The heat may then conduct through the component's mass more uniformly and efficiently, reducing thermal gradients and their corresponding thermal stresses. The heat may propagate into joints such as a rabbet joint having an interference fit. The rabbet joint may include a male portion (e.g., protrusion) inserted into a female portion (e.g., groove). By heating the female portion and/or cooling the male portion, the joint may become loosened. Indeed, the thermal changes may relieve the interference fit while also maintaining lower stress levels because of the uniform application of heat. In other embodiments, the heat may be applied to any surface or portion of a component so as to enable a loosening of interference fits. For example, the heat may be applied directly to the interference fit, to nearby components of the interference fit, or anywhere in the component's surface or mass.

The logic 84 may monitor a time (block 88) by the use of a microprocessor or any suitable timing device. Likewise, a temperature may be monitored (block 90), for example, by a temperature sensors such as a thermocouple, resistive thermal device (RTD), a thermistor, and/or non-contact optical temperature sensor. In certain embodiments, the time and temperature may be monitored so as to follow the temporal thermal profile 85 during application of the hot or cold medium 86. That is, the time and temperature may be monitored so as to approximate a desired temperature at a desired time as directed by the temporal thermal profile 85. For example, at time t₀ the desired temperature may be an ambient temperature. As time increases, the desired temperature may be increasing. Accordingly, when a certain time measure has been reached (decision 92), the logic 84 may then increase application of heat (block 94). If the time measure has not been reached (decision 92), then the logic may iterate back to monitoring a time (block 88) and monitoring a temperature (block 90). Likewise, if a certain monitored temperature (i.e., disassembly temperature) has not been reached (decision 96), then the logic 84 may iterate back to monitoring a time (block 88) and monitoring a temperature (block 90) so as more closely follow the temporal thermal profile 85.

In certain embodiments, if a desired time and/or a desired temperature has been reached, then the logic 84 may then cool the specific component or part of a component (block 86). The cooling may be applied to aid the separation of the interference joint. Accordingly, the cooling may be applied to the mated component that is not receiving the heat. For example, when a rotor wheel is mated to a spacer, the rotor wheel may experience the application of a hot medium while the spacer may experience the application of a cold medium. The cooling may also be applied to certain portions of the rabbet joint. For example, the female portion of the rabbet joint may be heated and therefore the male portion of the rabbet joint may be cooled in order to more quickly loosen the interference fit. Applications of a cold medium may include dry ice, chilled air, chilled water, and/or endothermic chemical packs. During application of the cold medium 86, the cold temperature may be monitored (block 88) and the time spent applying the cold medium may be monitored (block 90). Such monitoring may enable the application of the hot or cold medium to follow the temporal thermal profile 85 in order to more quickly loosen the joint. Accordingly, the logic 84 may continue the cooling (block 86) if a certain time measure has not been reached (decision 92) and if a certain temperature (i.e., disassembly temperature) has not been measured (decision 94). If a time has been reached (decision 92) or if the disassembly temperature has been measured, then a force may be applied (block 96). In certain embodiments, the logic 84 may use a hot medium without any cold medium.

A load (i.e., mechanical force) may be applied to the mated parts (block 96) to aid in the mechanical separation of the mated parts. For example, a lift, a winch, a hoist, or jack may be used to apply a load suitable for separating the mated components. By using the techniques disclosed herein, the amount of force used to separate the parts may be lessened due to the application of the hot and/or cold medium. Indeed, by following the temporal thermal profile during the application of thermal energy, the mated components may be more easily separated while reducing thermal and mechanical stresses. The mated components may then be disengaged from each other (block 98) and removed from the turbine system 10.

FIG. 4 is schematic view illustrative of an embodiment of an automation controller 106 (e.g., thermal controller, turbine tool controller) capable of controlling the application of a hot and/or a cold medium. The controller 106 may be a programmable logic controller (PLC), a proportional integral derivative (PID) controller, a computer workstation, or any other suitable controller device. In the depicted embodiment, the controller 106 may use the temporal temperature profile (TTP) 85 to heat a first turbine component 108 and/or to chill a second turbine component 110. The heating of the first component 108 and/or the chilling of the second component 110 may enable a joint, such as a rabbet joint having an interference fit, to become loosened. Accordingly, the controller 106 may be capable of controlling a heat source 112 (e.g., hot air blower, boiler, exothermic chemical) so as to enable the heating of a hot fluid such as hot air and/or hot water. The fluid heated by the heat source is delivered to the first turbine component 108 by a thermal disassembly tool 114. The thermal disassembly tool 114 enables the delivery of a hot fluid, for example, through fluid conduits such as pipes, bores, gaps, square tubing, and so forth. Such fluid conduits allow for the precise delivery of the hot fluid into difficult to reach areas such as the inside of a rotor wheel bore. Indeed, by employing flexible and/or rigid conduits, the thermal disassembly tool 114 may allow for the delivery of the hot fluid to various locations that are otherwise inaccessible or difficult to access.

FIG. 4 also depicts three sensors 116, 118, 119 and 121 connected to the controller 106. The sensors 116 and 118 are capable of communicating a temperature measure indicative of the temperature of the component 108 and 110, respectively. The sensor 119 is capable of communicating a temperature measure indicative of ambient conditions such as the ambient air near the turbine component 108 or 110. The sensor 121 is capable of communicating a temperature measure indicative of the thermal fluid entering the turbine component 108. The sensors 116, 118, 119 and 121 may include thermocouples, thermistors, RTDs, and/or optical sensors (e.g., non-contact temperature sensors). Indeed, a wide variety of temperature sensing devices may be used. In certain embodiments, the sensors 116, 118, 119 and 121 may be wireless sensors capable of communicating wirelessly with the controller 106. It is also to be understood that while FIG. 4 shows four temperature sensors, more or less sensors may be used. Indeed, temperature sensors may be placed in a variety of locations on the turbine components, nearby structures, locations in the heat source 112, and/or locations in heating tool 114 (e.g., inside of conduits).

The controller 106 is also capable of cooling the component 110. Accordingly, a cooling source 120 may be used to provide, for example, a chilled air, a dry ice, a wet ice, and/or an endothermic chemical coolant. In one embodiment, as the heat is applied to the component 108, the coolant may be applied to the component 110 so as to aid in maintaining a temperature differential between the two components 108 and 110. The temperature differential between the two components 108 and 110 may allow for an expansion in the dimensions or geometries of component 108, while component 110 may remain at its original dimension (or shrinks). These dimensional or geometry changes may thus loosen the joints securing the two components 108 and 110.

In certain embodiments, a loading force 122 may be applied to fully separate the two components 110 and 108. For example, the controller 106 may engage an actuator capable of controlling an apparatus such as lift, a winch, a hoist, and/or a jack. The apparatus may then apply the loading force 122 suitable for separating the component 108 from the component 110. In other embodiments, the loading force may be applied by a human operator. For example, the controller 106 may monitor a time and a temperature and may notify the human operator when the time and/or temperature have reached certain values (e.g., disassembly temperature). The human operator may then apply the loading force 122. By monitoring and controlling the thermal disassembly process, the controller 106 may enable a faster and more efficient disassembly of the components 108 and 110 while minimizing thermal stresses.

FIG. 5 is a cross-section view of embodiments of a rotor wheel 124 that is joined (i.e., mated) to a shaft 126 and to a spacer 128. The figure also depicts an embodiment of a thermal disassembly tool 130. In the depicted embodiment, the rotor wheel 124 is mated to the shaft 126 and to the spacer 128 through rabbet joints 132 and 134, respectively. The rabbet joints 132 and 134 may include an interference fit suitable for securely fastening the shaft 126 and the spacer 128 to the rotor wheel 124. Accordingly, the thermal disassembly tool 130 may be used to enable the disassembly of the rotor wheel 124 from the wheel bore 126 and the spacer 128. In the depicted embodiment, the thermal disassembly tool 130 includes a hot air blower 136 connected to a tube 138. It is to be understood that, in other embodiments, two or more hot air blowers 136 may be used. In yet other embodiments, heating sources such as a boiler, an exothermic chemical pack, and so forth may be used. Indeed, a variety of heating sources suitable for heating a fluid (e.g., liquid or gas), and a solid may be used to focus thermal energy.

The tube 138 is of a length suitable for traversing the entirety of the inner bore of the shaft 126 so as to deliver thermal energy to an inner portion 140 of the rotor wheel 124. The tube 138 may include a peripheral portion 142 that has multiple openings or holes 143. Such openings or holes 143 enable a flow of hot air 144 to exit the tube 138 and impinge directly onto a bottom surface of the inner portion 140. The hot air 144 impinging on the inner portion 140 may thus focus thermal energy at a position approximately near the bulk of the mass of the rotor wheel 124. That is, the thermal energy may be applied to a location 140 having a significant amount of mass. Such a thermal energy may then heat the rotor wheel 124 from the inside, thus allowing the heat to thermally conduct more uniformly through the mass of the rotor wheel 124 and into the rabbet joints 132 and 134. Such uniform conduction may result in the reduction of thermal gradients. Convective heating may also occur as the hot air 144 circulates, for example, inside a chamber 145. The convective heating may transfer additional thermal energy to the rotor wheel 124, thus reducing the amount of time spent in heating the rotor wheel 124.

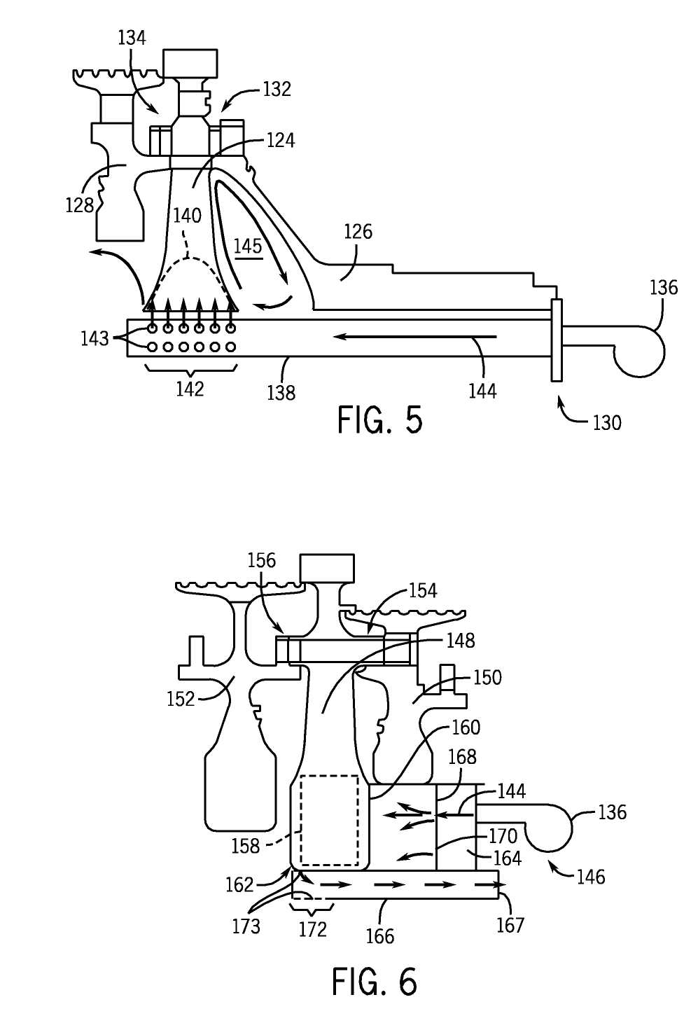

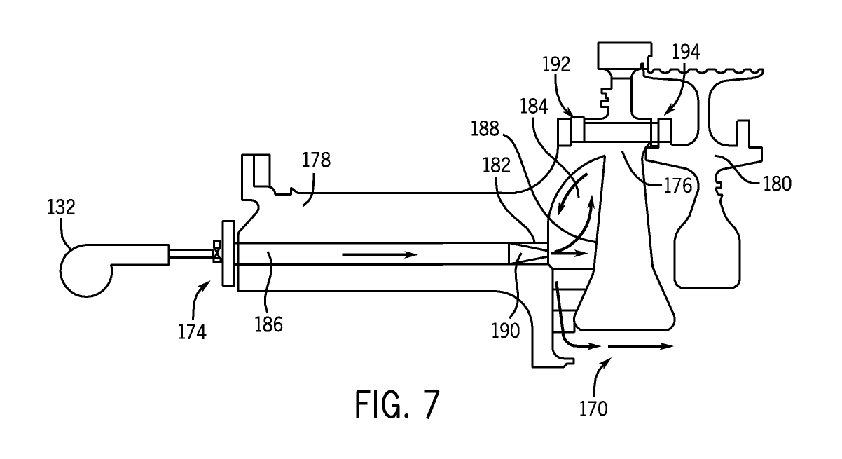

As mentioned above, the controller 106 may enable the heating of the rotor wheel 124 by following a temporal temperature profile 85. Accordingly, the controller 106 may actuate the hot air blower 136 so as deliver the hot air 144 into the rotor wheel 124. In one embodiment, the controller 106 may be capable of a closed loop feedback control. That is, a temperature is monitored and a response to the monitored temperature may be derived based on, for example, the temporal thermal profile 85. For example, if a temperature falls below a desired level, then the controller 106 may use the turbine tool 130 (e.g., thermal disassembly tool) to direct more hot air 144 and/or may raise the temperature of the hot air 144. Likewise, if the temperature rises above a desired amount, then the controller 106 may direct less hot air 144 and/or lower the temperature of the hot air 144 delivered by the thermal disassembly tool 130. Indeed, by enabling a feedback response to monitored temperatures, the controller 106 may more closely follow the temporal thermal profile 85, thus enabling a faster loosening of the rabbet joints while minimizing thermal gradients. Further, the controller 106 may control other thermal disassembly tool embodiments, such as the embodiments described in more detail below with respect to FIG. 6 and FIG. 7, to more closely follow the temporal thermal profile 85.

Additionally, the heating of the interior portion 140 may be accompanied by a simultaneous cooling of, for example, the outside walls of the shaft 126. Such a cooling may include covering the outside walls of the shaft 126 with a sleeve and adding dry ice to the region between the outside walls and the sleeve. Accordingly, the controller 106 may provide for a cooling time based on the temporal thermal profile 85. By simultaneously heating and cooling the turbine components, the disassembly time may be reduced while reducing thermal gradients.

FIG. 6 is a cross-section view of an embodiment of a turbine tool 146 (e.g., thermal disassembly tool) that may be used to enable the disassembly of a rotor wheel 148. In the depicted embodiment, the rotor wheel 148 is fastened to spacers 150 and 152 through rabbet joints 154 and 156. Because of the component geometries, a accessible inner portion 158 includes a wheel face 160 and a center bore 162. Accordingly, the thermal disassembly tool 146 may include a wheel face heating chamber 164 and a bore heating tube 166 suitable for heating the wheel face 160 as well as the center bore 162, respectively. In the depicted embodiment, the hot air blower 136 may direct the hot air 144 through the heating chamber 164. The heating chamber 164 may include multiple openings or holes, such as openings 168 and 170, spaced along on the wheel face 160. The heating chamber 164 may also be uniform or non-uniform. Non-uniform embodiments of the chamber 164 may provide more heat in certain areas. The hot air 144 may exit the openings 168 and 170 and directly impinge on the wheel face 160. The hot air 144 may then continue flowing through the center bore 162, and enter a bottom section 172 of the bore heating tube 166. There may be a small gap between the bottom section 172 and the center bore 162 that allows for the air to flow into the bottom section 172 of the bore heating tube 166. The bottom section 172 may include multiple openings or holes 173 suitable for increasing the intake of air that may flow through the bore heating tube 166. The hot air may then continue through the bore heating tube 166, exiting at an outer end 167 of the tube 166. That is, the air 144 may flow from the chamber 164, impinge upon the wheel face 160, enter the center bore 162, continue into the tube 166, and exit through the outer end 167. By heating both the wheel face 160 and the center bore 162, the thermal disassembly tool 146 may enable a faster and more efficient transfer of thermal energy into the mass of the rotor wheel 148.

As mentioned above, the controller 106 may enable the heating of the rotor wheel 148 by following the temporal temperature profile 85. The temporal temperature profile 85 may take into account the extra heating surface (e.g., the wheel face 160) of the rotor wheel 148 and direct the controller 106 accordingly. That is, the extra heating surface may allow for the controller 106 to apply more thermal energy because of the increased heating surface. The thermal energy may then uniformly conduct through the rotor wheel's mass and into the rabbet joints 154 and 156. The thermal energy is capable of loosening the interference or compression fit of the rabbet joints 154 and 156, thus enabling a faster disconnection of the rabbet joints 154 and 156 while minimizing thermal gradients.

FIG. 7 is a cross-section view of an embodiment of a turbine tool 174 (e.g., thermal disassembly tool) suitable for enabling the disassembly of a rotor wheel 176 that is mated to a turbine component 178 and to a spacer 180. In the depicted embodiment, the turbine component 178 may not include a central bore. Instead, the turbine component 178 may include one or more “gun” holes 182 (e.g. secondary flow holes) that traverse the turbine component 178. Such “gun” holes 182 may act as a fluid conduit between the exterior of the turbine component 178 and an interior chamber 184 of the rotor wheel 176. In this embodiment, the thermal disassembly tool 174 may include a tube 186 for each one of the “gun” holes 182. Each tube 186 includes a length suitable for traversing the hole 182. Accordingly, the hot air blower 136 may blow the hot air 144 into each of the tubes 186 of the thermal disassembly tool 174. The hot air 144 may exit the tube 186 and directly impinge into a wheel face 188 (e.g., inner portion) of the rotor wheel 174. In one embodiment, the tube 186 may include a nozzle 190. The nozzle 190 enables for the hot air 144 to be ejected in a coherent stream focused at the wheel face 188. Further, the nozzle 190 may increase the velocity of the hot air 144, thereby increasing the focus and heat transfer of the flow of hot air 144 impinging onto the wheel face 188. The hot air may also circulate in the interior chamber 184, thus transferring additional thermal energy into the rotor wheel 176. While the depicted embodiment shows a single hot air blower 136, it is to be understood that, in other embodiments, multiple hot air blowers 136 may be used. Additionally, other fluids such as liquids may be used to deliver thermal energy.

The controller 106 may administer the heating of the of the rotor wheel 176 by directing hot air through each of the tubes 186. As previously mentioned, the controller 106 may follow the temporal thermal profile 85 so as to more quickly and uniformly heat the rotor wheel 176 while reducing or minimizing thermal gradients. The applied heat may conduct through the mass of the rotor wheel 176, reaching rabbet joints 192 and 194 that fasten the rotor wheel 176 to the turbine component 178 and to the spacer 180, respectively. The applied heat may allow for the expansion of the female portion (e.g., groove portion) of the rabbet joints 192 and 194, relieving the compression or interference fit. A load may then be applied suitable for disengaging the rotor wheel 176 from the turbine component 178 and from the spacer 180. By using the thermal disassembly tool 174 to apply heat to the inner portion of the rotor wheel 176, the controller 106 may more quickly and efficiently enable the disassembly of the turbine components 176, 178, and 180.

Further, the heating of the wheel face 188 may be accompanied by a simultaneous cooling of, for example, the outside walls of the turbine component 178. Such a cooling may include covering the outside walls of the turbine component 178 with a sleeve and adding dry ice to the region between the outside walls and the sleeve. Accordingly, the controller 106 may provide for a cooling time based on the temporal thermal profile 85. Such a simultaneous heating and cooling may further reduce the time required to disassemble the turbine components.

Technical effects of the invention include the ability to quickly relieve an interference fit so as to disengage mated turbine components. Heating and/or cooling may be applied to various turbine components at selected locations. A temporal thermal profile may be created and then followed in applying the hot and/or cold medium. The temporal thermal profile enables a faster loosening of the interference fit while also minimizing any thermal gradients. Further effects include the reduction in the time and expense of maintaining the turbine system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a turbine tool configured to loosen an interference fit between a first component and a second component of a turbine system, wherein the turbine tool is configured to apply a thermal medium to an inner portion of the first component of the turbine system.

2. The system of claim 1, wherein the turbine tool comprises a thermal source coupled to a conduit.

3. The system of claim 2, wherein the conduit is configured to extend into an interior of the first component.

4. The system of claim 1, wherein the inner portion comprises a wheel face, a wheel bore, or a combination thereof.

5. The system of claim 3, wherein the conduit comprises a plurality of openings adjacent the inner portion of the first component.

6. The system of claim 2, wherein the thermal source comprises a fluid source.

7. The system of claim 1, wherein the turbine tool comprises a hot thermal source configured to apply a hot thermal medium to the inner portion of the first component, and the turbine tool comprises a cold thermal source configured to apply a cold thermal medium to the first component, to the second component, or to both the first and second components.

8. The system of claim 1, comprising a thermal controller coupled to the turbine tool, wherein the thermal controller is configured to control application of the thermal medium to the first component to loosen the interference fit between the first component and the second component of the turbine system.

9. The system of claim 8, wherein the thermal controller comprises a thermal and structural model having a temporal temperature profile relating to the application of the thermal medium to the first component.

10. The system of claim 8, wherein the thermal controller comprises a thermal feedback controller configured to control the turbine tool in response to temperature feedback relating to the first component.

11. The system of claim 1, comprising a thermal and structural model, wherein the thermal and structural model is used to time the application of the thermal medium.

12. A system, comprising:
a turbine tool controller configured to control a turbine tool to loosen an interference fit between a first component and a second component of a turbine system, wherein the turbine tool controller is configured to control application of a thermal medium by the turbine tool to an inner portion of the first component of the turbine system.

13. The system of claim 12, wherein the turbine tool controller is configured to control application of the thermal medium to the first component to thermally expand the first component relative to the second component.

14. The system of claim 12, wherein the turbine tool controller comprises a thermal and structural model having a temporal temperature profile relating to the application of the thermal medium to the first component.

15. The system of claim 14, wherein the thermal and structural model is based on computational fluid dynamics (CFD), a finite element analysis (FEA), a solid modeling, a 3-dimension to 2-dimension FEA mapping, or a combination thereof.

16. The system of claim 12, wherein the turbine tool controller comprises a thermal feedback controller configured to control the turbine tool in response to temperature feedback relating to the first component, the second component, or a combination thereof.

17. A method, comprising:
applying a thermal medium to an inner portion of a first component of a turbine system; and
controlling application of the thermal medium to loosen an interference fit between the first component and a second component of the turbine system.

18. The method of claim 17, wherein applying the thermal medium comprises internally flowing a hot fluid through the first component to thermally expand the first component relative to the second component.

19. The method of claim 17, wherein controlling application of the thermal medium comprises substantially following a temporal temperature profile of a thermal and structural model.

20. The method of claim 18, comprising cooling a first outside wall of the first component, cooling a second outside wall of the second component, or a combination thereof.
